(19) United States
(12) Patent Application Publication
(10) Pub. No.: US 2015/0193837 A1
(43) Pub. Date: Jul. 9, 2015

(54) METHOD OF ALLOCATING AND DISTRIBUTING MONETARY CAMPAIGN CONTRIBUTIONS

(71) Applicant: James Walter Moore, Albuquerque, NM (US)

(72) Inventor: James Walter Moore, Albuquerque, NM (US)

(21) Appl. No.: 13/439,383

(22) Filed: Apr. 4, 2012

Related U.S. Application Data
(60) Provisional application No. 61/516,748, filed on Apr. 6, 2011.
(60) Provisional application No. 61/516,562, filed on Apr. 4, 2011.

(51) Int. Cl. G06Q 30/02

(52) U.S. Cl. CPC G06Q 30/0279

(57) ABSTRACT

A performance-based method of allocating and distributing campaign contributions using a computer system accessible through an interactive interface, like a web site or mobile application. The computer system collects monetary campaign contribution pledges from Donors, the pledges being associated with a particular piece of legislation rather than a particular candidate. The Donor indicates whether they are for or against the legislation when making their pledge. The computer system then monitors the legislative body's action on the legislation and once voted on, it allocates pledge funds to incumbents or their challengers based on how the incumbent voted. Multiple Donors' allocated pledges for multiple pieces of legislation are accumulated over time per seat. At the end of each seat's term, the pledges are then distributed accordingly. Thus, a contribution decision is ultimately made based on an incumbent's record rather than on his or her promises.

This application claims priority to and the benefit of the filings of U.S. Provisional Patent Application Ser. No. 61/516,562, entitled “Method of Allocating and Distributing Campaign Contributions,” filed on Apr. 4, 2011, and U.S. Provisional Patent Application Ser. No. 61/516,748 entitled “Method of Allocating and Distributing Campaign Contributions,” filed on Apr. 6, 2011, and the specifications thereof are incorporated herein by reference.

### FIELD OF THE INVENTION

The field of the present invention is campaign financing. The present invention relates to legislative elections, particularly, a method of collecting monetary campaign contribution pledges associated with proposed legislation or legislation pending before a legislative body, monitoring the legislative body's action on the legislation, allocating funds to incumbents in the legislative body or their challengers based on each seat's vote on the legislation, and distributing the Donor's contribution to the incumbent's or challenger's campaign fund accordingly. Thus, a contribution is ultimately made based upon a Donor's evaluation of a legislative seat's performance record, integrated over time and issues, rather than on the candidate's promises.

### BACKGROUND OF THE INVENTION

The campaign financing of candidates for office in the United States is a very sophisticated and intricate system. In the very early years of the Republic, there were not campaigns as we know them today. Service was nominally voluntary, at the legislator's personal expense (or benefit). The voter pool was relatively small (white male property owners only) and there was really no need, means, or concept of mass advertising or marketing. As the Republic and the voter pool grew, the art of campaigning for office, i.e., promoting one's fitness to serve, began.

At first, campaigning efforts were financed mostly by the personal fortunes of the candidate. In 1828, Andrew Jackson was the first presidential candidate to solicit private contributions and run an election “campaign” as we might recognize today. Yet 20 years later, Lincoln nearly bankrupted himself financing his own campaign. With the advent of radio and television, the expenses associated with campaigning began to exceed the fortunes of all but very few wealthy citizens. The practice of soliciting private contributions, based on some unspecified future benefit for the Donor, became the norm and has continued fundamentally unchanged for over 180 years.

Based on 2008 data, an average campaign for a US House of Representatives seat costs each candidate an average of $980,000 every two years. Raising competitive sums is fraught with temptation and opportunity for buying and selling special influence with relatively few wealthy people. It is clearly more efficient use of the candidate's time to concentrate on relatively few “significant” Donors. The evidence for this phenomenon is clear in the campaign finance data collected over the past decade or so. As shown in Table 1, in 2008, only 0.8% of those that actually voted made any contributions to incumbents or challengers. More importantly, 70% of all funds raised came from less than 0.3% of those that voted.

TABLE 1
US Congress Campaign Receipts, 2008

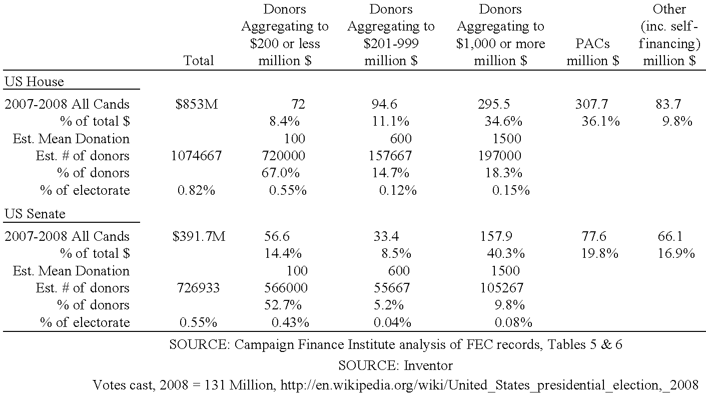

The statistics cited above are not indicative of a healthy representative government. Campaign finance is clearly a serious problem for the legislative candidate. It has been estimated that Congressmen must spend nearly half of their time raising campaign funds at a rate of about $10,000 per week. It is only natural then that a legislator might be willing to provide special access and influence to their significant contributors.

Another relevant concern in the art of campaign finance is the impact of Dunbar's number on a self limiting aspect of the traditional campaign finance system. The traditional method of campaign finance is based on a relationship or agreement between two individuals (Donor and Candidate) with the candidate seeking funds in exchange for some sense of loyalty, friendship, common purpose, or unspecified future benefit for the Donor. The specific purpose is irrelevant here, but in this relationship the candidate must maintain some sense of “specialty” of the relationship in the eye of the Donor. If the Donor begins to feel like just a number, rather than a “special” contact, he may withdraw or reduce his participation (contribution) in the relationship. Dunbar's number suggested a cognitive limit to the number of people with whom one can maintain stable social relationships of between 100 and 230. Obviously, these donor/candidate relationships are not social relationships, but Dunbar's research may suggest that there will be some limit on the number of donors that a candidate can make feel “special.” The inventor speculates that this number must lie between Dunbar's upper limit of 230 and 1000 based on general human capability to resolve individual things. i.e. humans are incapable of resolving one missing friend (or apple) out of 1000 friends (or apples).

From the campaign finance data in Table 1, we can derive that, on average, some 65% of the collected funds in fact comes from about 300,000 individuals, to roughly 930 candidates, or 322 donors per candidate, that feel “special” enough to donate more than $1000. (PAC contributions are included in this 65% because their contributions are decided by a small board of directors, many of whom are the same people donating over $1000 on their own) This observed average number of 322 major donors is consistent with the concept of Dunbar's number. With such a limited capability of about 350 donors that can feel “special”, and the current $2,500 individual contribution limit, a candidate will begin to run into a campaign finance wall of about $875,000 that can be raised for his pending campaign.

The proposed new method of campaign finance is not impacted by the concept of Dunbar's number. The Donors in this new system have no expectation of feeling “special:” They know that they are one of millions of Donors, and not individually resolvable to any candidate. It is also relevant to note that the 930 candidates are not resolvable to the donors either. This unresolvablility of donors and candidates produces a system incapable of supporting special influence or producing actionable political debt.

In recent decades, there have been attempts to remedy many of these issues through “public financing” of campaigns. Yet this too has been problematic. Consensus on who will get how much money has been elusive. It may be irrational to expect legislators to devise, or even approve, any campaign finance system that would fairly fund their challengers with public funds. A significant feature of this invention is that it requires no changes to current campaign finance law to be effective.

While there are examples in the prior art of methods for collecting and distributing contributions over the internet, none have the advantages of the present invention.

For instance, U.S. Pat. No. 7,870,067 to Crowl discloses a donation system that acts as a contribution bundler and is designed to encourage small contributions by individuals to a charity or political campaign.

Additionally, U.S. Pat. No. 6,898,575 to Mull discloses an electronic Donor directed charitable donation system whereby Donors direct the disposition of donations and donees access the donations and promise to use the donations only for the specified purpose(s).

Finally, U.S. Pat. No. 6,092,052 to Ziarno discloses a method of capturing monetary donations at places and times where Donors are most motivated and sending the Donor/donation information to a remote processing device for processing the donation.

Nothing in the prior art provides the unique benefits afforded by the present invention.

### SUMMARY OF THE INVENTION

The present invention addresses the problems described above with an entirely different method for campaign finance. The method of the present invention funds legislative campaign expenses on the basis of the actual voting record of incumbent legislators. It is an all-encompassing system, designed specifically for financing campaigns, based on many small contributions, with built-in rewards and penalties, checks and balances, rather than the painfully evolved system we have been using for over a century. For example, the method would finance an entire Congressional campaign on $10 per year per person from 50% of the electorate, compared with the current system struggling to raise $2,400 per election from less than 0.3% of the electorate. The main objective is to provide ordinary citizens with an ethical, attractive, and effective means of participating in funding the campaign expenses of electing our representative government. It is designed to entice tens of millions of citizens, perhaps not currently involved in the process, to provide their influence on the final outcome of legislative elections.

The main objective of the present invention can only be achieved via a particularly inventive combination of several relatively recent technological developments. Those technological developments are relatively inexpensive and comprise: (1) mass communication via the internet, and (2) massive computing power. Neither of those necessary elements was available during most of the evolutionary period of our current system for campaign finance.

The method of the present invention funds legislative campaign expenses on the basis of the actual legislative performance of incumbent legislators, as judged by the citizen Donor. It is a process involving three distinct phases working together over time. The first phase is creation of individual monetary campaign contribution pledges by individual Donors to participate in funding the future elections of an entire legislative body. The second phase is the allocation of those funds to individual seats within the legislative body. Allocations of rewards and penalties are determined by the actual legislative actions of the legislators per criteria specified by Donors during the creation of their individual pledges. The last phase is the integration of multiple allocations, made over each legislator's term, into aggregated contributions to bona fide candidates for office within the legislative body. These contributions are reflective of each Donor's satisfaction or dissatisfaction with the overall legislative performance of each seat within the entire legislative body.

There are significant advantages of the method of the present invention over the traditional campaign contribution system.

One advantage is that the method functions on the aggregated influence of many (necessarily millions) Donors on the entire collection of legislators within a body, rather than on the influence of individual Donors on individual legislators.

Another advantage is that the pledges are “sold” by a broker. Accordingly, all of the legislator's time is available to understand issues and attempt to educate his colleagues and the electorate on them. Previously, the “selling” of special influences (future benefit) takes much of the representative's time.

Still another advantage of the present invention is that the method determines the available campaign funds for an individual Incumbent and their Challengers based on how the Incumbent's actual vote is aligned with the interests of the Donors. It does not matter how “smooth” a legislator is at selling promises or at hiding the fact when they must break them.

Yet another advantage of the present invention is that it provides legislators with an alternative and ethical funding source capable of overwhelming special interest sources.

Further, the success of the method of the present invention is dependent on numerous small pledges which would be considered impractical, troublesome, and undesirable within the traditional campaign funding system.

Also advantageous is that whether a specific Bill passes or fails, the Donor's contribution always goes toward the Donor's political wish at the time of the vote.

Finally, the method of the present invention does not require exclusivity. It is expected to absorb the current “generous” Donors as a more effective and ethical means of political participation. It is also capable of overwhelming corrupt elements of the current system, making them insignificant.

The method of the present invention is a new concept which is enabled only by new tools of the current information age. It seeks to empower ordinary citizens to dominate the previous political powers with only their pocket change. The social consequences of the present invention are difficult to comprehend, or predict. However, some of the goals of the method are to fundamentally change the campaign financing system in the U.S., provide easy access to information needed for an informed, democratic process to thrive, increase citizen participation in the political process, increase voter registration, and absorb the current “special interests” and make them relatively less significant.

In the preferred embodiment of the invention, the Donors first choose a pending legislative action that they wish to use as an element for evaluation of the legislative performance of an entire legislative body. As defined below, the invention contemplates more than just the United States Congress. The present invention is well-suited for application to state legislatures, federal or state commissions, local governing entities such as school boards, etc. Any such “legislative body” whose members are elected to serve for a term and who make decisions—i.e., they take “legislative action”—could receive campaign contribution pledges and allocations using the method of the present invention.

Next, the Donors pledge a small amount of money to be applied to funding a pending election of that entire body. They also specify their own criteria for evaluation of the performance of the body relative to their selected legislative action. Millions of these small elemental expressions of individual legislative desire may be made anonymously, prior to a final legislative vote on the specific action. If these pledges are made anonymously, it can be assured that Donors cannot sell individual political debt to legislators since they do not know who has pledged how much money on any specific legislative action. Additionally, Donors do not know which specific legislative seats will ultimately receive benefit or penalty from their pledge. Rather, pledges are initially made to an entire legislative body.

Next, pledges are allocated following a final floor vote on the specific legislative action. Once a legislative vote on a specific action is completed, the funds that were committed by individual Donors can be allocated to individual seats in the form of reward or penalty. Reward pledges are allocated to those seats that voted in support of each Donor's desire while penalty pledges are allocated to those seats that voted in opposition to each Donor's desire. Again, allocations are made to seats within the legislative body. Over the term of each seat, multiple allocations, from individual Donors, derived from multiple pledges from those individual Donors, can accumulate in each seat's reward and penalty allocation pools. Over time, these allocation pools become a precise mathematical integral of each Donor's evaluation of that seat's legislative performance on matters of interest to each specific Donor. Incremental allocations are made to specific legislative seats based on a comparison of each seat's voting performance with predefined criteria specified by individual anonymous Donors.

Finally, near the end of each seat's term bona fide candidates for that seat will be identified, for instance, by successfully becoming listed on a general election ballot. At this point, the funds contained in the aggregated reward pools are distributed to the election campaign funds of the identified incumbent candidates of the seats up for election. The funds contained in the aggregated penalty pools are distributed to the election campaign funds of the identified challenger or challengers seeking those seats. The pledges, once distributed, become campaign “contributions” within the meaning of the relevant campaign finance law in effect at that time and in the appropriate jurisdiction. Therefore, contributions made to identifiable candidates could include the identities and total contribution amounts of each Donor depending on the applicable law. The number of pledges for any particular legislative action or whether the funds received were associated with having voted for or against any particular legislative issue may never be revealed to the incumbent or challenger(s). In that case, incumbents would only know that the received aggregated contribution reflects Donor satisfaction with their legislative performance over their preceding term. Challengers would only know that the received contribution reflects Donor dissatisfaction with the legislative performance of the incumbent over their preceding term.

Consideration of the computational needs of the method of the present invention for allocation and distribution of campaign contributions provides insight as to why this method was not possible prior to the advent of current technologies in mass communication and raw computational power. In order to be competitive with the traditional system, this new method must generate approximately $500 million per year, to be allocated between about 950 candidates, using the United States Congress as an example. If we assume an average Donor pledge of $10 on a piece of legislative action, this represents some 50 million pledges per year. Assuming an 18 hour day over 365 days per year, then roughly 7600 pledges per hour or 2 pledges per second will be made. This rate can be approximately estimated to vary by plus or minus 20 times (0.1 to 40 pledges per second). This input job would take an estimated 2,500 telephone operators and consume at least 45% of the $10 value of the pledge. This overhead fee would probably be unacceptable to Donors.

These 50 million pledges will each need to be allocated into potentially 4 different allocation pools: incumbents who voted for and against the legislative action and challenger(s) of incumbents who voted for and against the legislative action. This means approximately 200 million specific allocations must be performed per year. Assuming a 24 hour day, 365 days per year yields an estimated 6.5 allocations per second. Performing this allocation job would require at least as many workers, with more skill than the input job, and therefore probably consume at least the rest of the $10 pledge.

Also in the preferred embodiment, pledges are made through a web site via a broker before the legislative vote takes place. The Donor must provide certain information such as their name, address, occupation, employer, and perhaps voter registration ID number, to open an account on the web site with the broker. The information would, at a minimum, ensure that any ultimate contribution can be traced back to a particular person pursuant to applicable campaign finance law requirements.

The Donor pledge also consists of the following instructions to the broker for allocation of the pledge between the legislative seats:
a) An identified piece of legislative action that the Donor wants to use as an element for evaluation of the performance of the legislative body. This is called a “Bill”, but could be any introduced Bill, resolution, appointment confirmation, or other legislative, regulation, or rule making action. This could also be a proposed legislative action, or “Issue,” rather than a Bill, that a Donor(s) would like to see introduced as legislative action. These Issues choices would be filtered and provided on the web site by the broker for selection by Donors. A Donor could only have one pledge on one Bill. But a Donor could have multiple active pledges on multiple Bills and Issues concurrently.
b) An amount of the monetary campaign contribution pledge the Donor wants to commit, on the selected action, to contribute toward the next election of all seats within the legislative body. Once committed, the monetary amount pledged on a Bill cannot be reduced by the Donor. This is necessary to prevent Donors from “gaming” this method by removing their pledge immediately prior to a legislative vote. A Donor would be allowed to remove monetary commitment from a pledge on a Donor-proposed Issue.
c) An indication of how strongly the Donor is for passage of the Bill or Issue. This would normally be 100% or 0%, but in fact can be anything in between. An indication of 0% would indicate that the Donor is against passage of the action. This indication produces a split of the pledge into a “Pro Split” portion, for passage of the action, and a “Con Split” portion, against passage of the action. Either of these two portions may contain 0% of the original pledge.
d) An indication of how the Donor wants to use the Pro Split portion of the pledge to penalize seats that vote against his Pro desire, and/or reward seats that vote in support of his Pro desire. The Donor indicates how much of his Pro Split he wants to use to penalize seats that vote against the Bill. This would be between 100% and 0%. This selection produces a split of the Pro Split portion of the pledge into a “ProPenalty Split” portion, for penalty of seats that vote against the Bill, and a remaining “ProReward Split” portion, for reward of seats that vote for the Bill.
e) An indication of how the Donor wants to use the Con Split portion of the pledge to penalize seats that vote against his Con desire, and/or reward seats that vote in support of his Con desire. The Donor indicates how much of his Con Split he wants to use to penalize seats that vote for the Bill. This would be between 100% and 0%. This selection produces a split of the Con Split portion of the pledge into a “ConPenalty Split” portion, for penalty of seats that vote for the Bill, and a remaining “ConReward Split” portion, for reward of seats that vote against the Bill.
f) An indication of how the Donor wants to address a situation where one or more seats do not vote for or against a Bill or Issue for some reason, such as abstain, absence, or possibly no vote. The Donor could have the choice to “enforce” his pledge, with its rewards and penalties, onto non-voting seats by directing the broker to treat all seats that did not vote as if they had voted against passage. Alternately, the Donor could chose to not enforce his pledge onto not voting seats by directing the broker to leave non-voting seats out of the allocation process and thereby receive no reward or penalty for not voting.
g) An indication of how the Donor wants to handle candidates that might refuse to accept a contribution created by this method. One possibility here is to “flip” the contribution and make the contribution instead to the refusing candidate's opponent(s). If no candidate for this seat would accept this contribution, it could remain in that seat's penalty allocation pool, through the next term(s), until it is finally accepted by some future challenger for that seat. Another possibility is to simply return the contribution to the Donor.
h) Any remaining portions of a pledge that could not be allocated for any reason might be returned to the donor. For example, in case of a unanimous vote for passage, there would be no seats to allocate the Con Reward or the Pro Penalty Splits between, unless a few absent seats from such a unanimous vote could be allocated the combined enforced Con Reward and Pro Penalty portions of all Donor pledges on this action.
i) A Donor could change pledge parameters c) through g) above at any time during legislative deliberation, up until a final floor vote, on the legislative action.

An upper limit for a Donor pledge on a single Bill is estimated to be about 20% of the current individual campaign contribution limit to an individual candidate of $2,500, or $500. This assumption assures that all participants would be able to create a pledge on at least five Bills before exceeding current campaign contribution limits. It would be statistically extraordinary for a Donor to achieve this five Bill $2,500 limit. A Donor would be more likely to exceed his $46,000 per election limit by creating $500 pledges on 92 Bills. A nominal pledge of $10 could produce a set of contribution elements to roughly half of the incumbents and roughly half of the challengers of nominally 10 cents each in the US Senate for example. This nominal $10 pledge to the US House of Representatives would yield contributions to half the incumbents and half of the challengers of nominally 2.3 cents each. A $500 limited pledge would nominally produce contribution elements in the Senate of $5 each to half of the incumbents and half of the challengers.

In the preferred embodiment of the invention, the broker holds the pledged funds in escrow to assure that they are available to fund the next election. The Broker then combines and integrates all the pledges on a Bill prior to the legislative vote. The Broker may publish a subset of this data, which consists primarily of the numbers of pending pledges for, pledges against, and the reward and penalty currently associated with the Bill. This report might look like FIG. 3.

The Broker may also publish the dollar amounts accumulated in the penalty category that is ultimately destined for contributions to future challengers of incumbents. However, the publication of dollar amounts available as rewards for incumbents could arguably run afoul of gratuity and bribery laws. But by collecting and publishing selective data prior to the vote as allowed by law, the Broker is able to produce competition between existing and potential Donors of opposing views, thus increasing the participation of new and existing Donors.

Following a final vote on a legislative action, the Broker allocates each individual pledge between individual seats within the legislative body per the Donor's wishes (as defined prior to the vote). These allocations to legislative seats continue to be held by the broker, in reward and penalty allocation pools associated with each seat. Over each seat's term, these reward and allocation pools accumulate allocations from multiple pledges from multiple donors.

These pools accumulate over each seat's term until candidates, both incumbents and challengers, for each legislative seat are identified. One method of identifying these candidates could be by their becoming listed on a general election ballot for a specific seat. Once identified, the reward pools would be distributed as a campaign contribution to the incumbent candidate, if one exists, running for re-election to occupy that seat, and the penalty pools would be distributed as campaign contribution(s) to the challenger candidate(s), if one exists, running for election to occupy that seat. If allocations cannot be distributed according to the Donor's instructions in the original pledge, the Donor can also specify what they want done with these unallocated funds. For instance, if no incumbent candidate exists, the reward allocation pool could automatically fall into the penalty allocation pool to be equally distributed as campaign contribution(s) between the remaining candidate(s) for that seat. And if there are no challenger candidate(s), the penalty allocation pool could continue to accumulate pledge penalty allocations through the next term of the incumbent.

Pledge allocations derived during the period between the first distribution to identified candidates and the actual end of the seat's term could be distributed as above to incumbent and non-incumbent candidates regardless of who actually won the election. This would empty the distributable portions of the allocation pools in preparation for the next term of each seat.

Over time, the operation of this method of campaign finance of the present invention would create data which would allow the broker to compile and publish additional statistical reports on the performance of legislative seats relative to all or selected subgroups of Donors' desires during a term, and over multiple terms. Of course a single donor could also view a comparison of any seat's historical performance relative to his individual Pledges. This type of information could be useful to citizen voters trying to decide whether to return an incumbent representative to office in an election or whether to make additional traditional campaign contribution to candidates for elected offices.

The operation of this method of campaign finance of the present invention would also create data which would allow the broker to compile and publish statistical reports on the relative funding of legislative candidates from this aggregate method compared with traditional methods of campaign finance. Again this information would be very useful to citizens considering their voting choices.

The operation of this method of campaign finance of the present invention would also create data which would allow the broker to compile statistical reports on the demographic data of participating Donors relative to their indicated legislative desires. Candidates might even be willing to purchase these reports.

### BRIEF DESCRIPTION OF THE DRAWINGS

FIG. 1 is a high level flow chart of the method of the present invention.

FIG. 2 is a more detailed flow chart of the method of the present invention.

FIG. 3 shows a hypothetical published status report on a bill.

### DETAILED DESCRIPTION

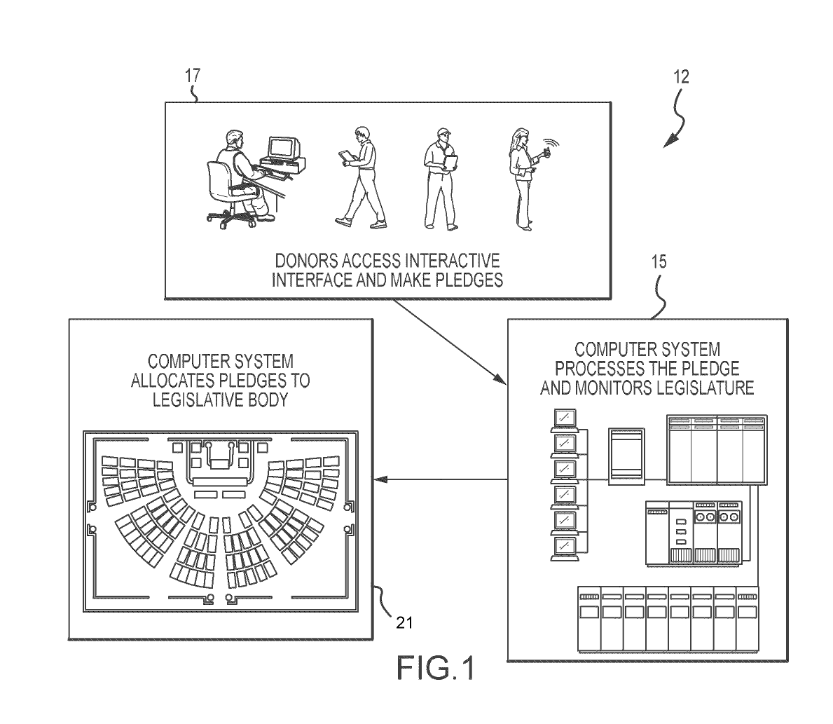

With reference to FIG. 1, the method of allocating monetary campaign contributions 12 using a computer system 15 accessible through an interactive interface 17 and programmed to process and allocate monetary campaign contribution pledges 15 from one or more Donors 17 to a legislative body 21 is shown. As depicted in FIG. 1, the Donor may access the interactive interface through any manner, including but not limited to, a desktop or laptop computer, a tablet or mobile computer, a smart phone, or a cell phone 17.

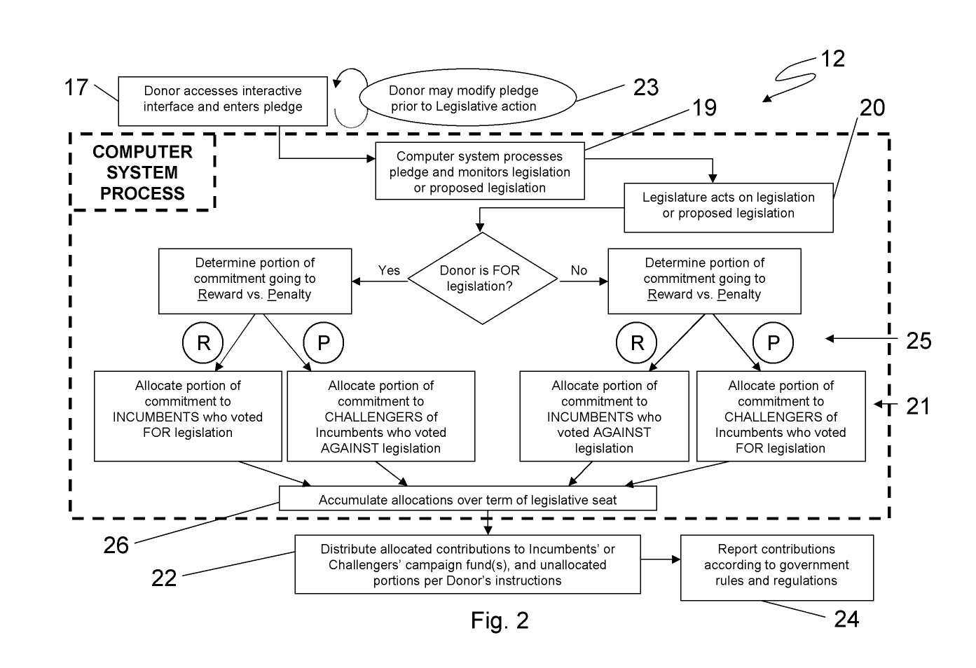

With reference to FIG. 2, the method of allocating monetary campaign contributions 12 using a computer system accessible through an interactive interface 17 and programmed to process and allocate monetary campaign contribution pledges from one or more Donors 17 is shown. While accessing the interactive interface, the Donor enters a monetary campaign contribution pledge 17 by identifying a piece of legislation pending before a legislative body, indicating whether the Donor is either for or against passage of the legislation; and identifying the amount of the monetary campaign contribution pledge. The legislative body consists of one or more seats, each seat having an incumbent capable of voting either for or against the legislation. The incumbent occupies the seat for a term at the end of which the incumbent may run against one or more challengers for the seat. The incumbent and the challenger(s) would maintain election campaign funds for the purpose of running for the seat.

The computer system then processes the monetary campaign contribution pledge and monitors the legislative body's action on the legislation 19. Once the legislative body has acted on the legislation 20, the computer system allocates the monetary campaign contribution pledge to the seats of the legislative body such that if the Donor indicated they were for passage of the legislation, the Donor's monetary campaign contribution pledge is allocated to seats whose incumbents voted for the passage of the legislation and if the Donor indicated they were against passage of the legislation, the Donor's monetary campaign contribution pledge is allocated to seats whose incumbents voted against the passage of the legislation 21. The computer system may also accumulate allocations over time such that allocations from multiple Donors on multiple pieces of legislation are distributed together 26.

The Donor's monetary campaign contribution pledge is then distributed to incumbents' or challengers' campaign funds according to the allocation 22 and the monetary campaign contribution pledges become contributions upon distribution. If, for whatever reason, a portion of the monetary campaign contribution pledge cannot be allocated, that portion becomes an unallocated portion of the monetary campaign contribution pledge which will be allocated based on instructions provided by the Donor 22 while making their pledge. Donors' contributions may be reported according to government rules and regulations.

Donors may modify certain aspects of their pledge 23. While entering their pledge, Donors may also provide their demographic data 17. Some of this data may be kept confidential unless and until reporting requirements require disclosure. However, statistical reports on certain demographic data may be useful. This data, as well as the number of Donors for or against any legislation, may be published.

In addition to the allocation process just described, where Donors reward incumbents who vote for legislation if the Donor was for it or who vote against legislation if the Donor was against it, the Donor may also specify a reward or penalty portion of the monetary campaign contribution pledge 25. This is indicated in FIG. 2 by an “R” with a circle around it for “Reward” and a “P” with a circle around it for “Penalty” 25. In this scenario, the reward portion of the pledge is allocated to rewarding incumbents who voted for passage of the legislation if the Donor was for passage of the legislation or incumbents who voted against passage of the legislation if the Donor was against passage of the legislation, the same as the allocation process described previously. 21 Additionally though, the penalty portion is allocated to penalizing incumbents who voted for passage of the legislation if the Donor was against passage of the legislation or incumbents who voted against passage of the legislation if the Donor was for passage of the legislation 21. Specifically, the penalty portion is allocated to at least one challenger for occupation of seats whose incumbents voted against the passage of the legislation if the Donor indicated the Donor was for the legislation and to at least one challenger for occupation of seats whose incumbents voted for the legislation if the Donor indicated the Donor was against the legislation 21.

Finally, rather than enter a monetary campaign contribution pledge and identifying a piece of legislation, the Donor may instead identify a proposal for a piece of legislation 17. The computer system monitors the proposed legislation 19 and if the proposal actually becomes legislation 20, this pledge on a proposed piece of legislation is converted into a pledge on an actual piece of legislation as described above. If the proposal for a piece of legislation does not become legislation 20, the Donor's monetary campaign contribution pledge may be returned to the Donor or distributed as an unallocated portion of the pledge.

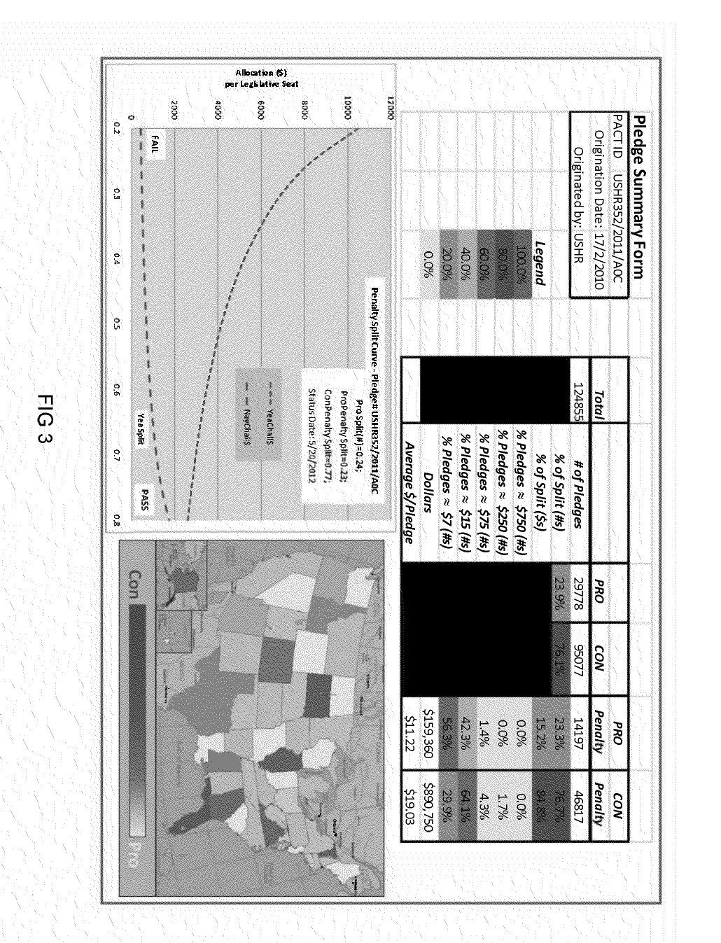

FIG. 3 shows a hypothetical status report on pledges associated with hypothetical Bill 352 in the US House of Representatives. In this hypothetical situation, the Bill currently has pledges from 124,855 Donors. The report depicted in FIG. 3 represents only the status of a portion of the eventual aggregated contribution derived from multiple such pledges. (The reward portions of the pledge have been withheld as explained below.) It can be seen in FIG. 3 that 76% of the Donors are Con (against passage). Of these 95,700 Con Donors, 46,817 (76.7%) of them chose to allocate penalty to seats voting for passage of this Bill, 64% of them allocated between $10 and $45, and the average penalty portion of these Con Donors was $19. A “Split Curve” in the lower left shows the resulting penalty, in the form of allocations to challengers of seats voting Yea and to challengers of seats voting Nay, to individual House seats as a function of the possible final voting ratio of the legislative body. We can see that in this hypothetical case, if the final vote is 30% Yea (i.e. the Bill fails), the 130 seats that voted for passage would each face penalty allocations of $6,945 (from 46,817 Donors @ $0.148 each) to their opponents in the next election. It is selectively not disclosed what reward allocation these Yea voting seats would receive. The map in the lower right shows the Pro/Con tendencies of different areas of the country. Each state could be color coded to represent its Pro/Con status. A user would ideally be able to click on a State and view the Pro/Con tendencies by district, county, or even zip codes.

As used herein, certain terms have the following definitions:

A “computer system” is a system that includes a computer or one or more interconnected computers, software, a central storage system and may also include various peripheral devices such as one or more printers, scanners, or routers.

A “Donor” may be an individual or a legal entity of any type.

An “interactive interface” is a Donor-computer interface provided by a desktop or laptop computer, a tablet or mobile computer, a smart phone, cell phone or any device that can be controlled by the Donor and that facilitates the flow of information between the Donor and the computer. Interactivity is provided by software which accepts and responds to input from the Donor.

A “legislative body” is an entity that contains at least two people who are elected to serve on the legislative body for a term, and who make, amend or repeal laws, rules, orders, regulations, ordinances or the like.

“Legislation” is a proposed or enacted law, rule, order, regulation, ordinance or the like.

“Software” includes a set of programs, procedures, algorithms, documentation, and data held in the storage of a computer for the purpose of facilitating the operation of a data processing system.

Whereas the figures and description have illustrated and described the concept and preferred embodiment of the present invention, it should be apparent to those skilled in the art that various changes may be made in the form of the invention without affecting the scope thereof. The detailed description above is not intended in any way to limit the broad features or principles of the invention, or the scope of patent monopoly to be granted.

1. A method of allocating monetary campaign contributions using a computer system accessible through an interactive interface and programmed to process and allocate monetary campaign contribution pledges from one or more Donors, the method comprising:
a. a Donor accessing the interactive interface and entering a monetary campaign contribution pledge by:
i. identifying a piece of legislation pending before a legislative body, the legislative body consisting of a plurality of seats, each seat having an incumbent capable of voting either for or against the legislation, the incumbent occupying the seat for a term at the end of which the incumbent may run against at least one challenger for occupation of the seat, the incumbent and the challenger each maintaining at least one election campaign fund for the purpose of running for the seat;
ii. indicating whether the Donor is either for or against passage of the legislation; and
iii. identifying the amount of the monetary campaign contribution pledge;
b. the computer system processing the monetary campaign contribution pledge;
c. the computer system monitoring the legislative body's action on the legislation; and
d. the computer system allocating the monetary campaign contribution pledge to the seats of the legislative body such that:
i. if the Donor indicated the Donor was for passage of the legislation, the Donor's monetary campaign contribution pledge is allocated to seats whose incumbents voted for the passage of the legislation; and
ii. if the Donor indicated the Donor was against passage of the legislation, the Donor's monetary campaign contribution pledge is allocated to seats whose incumbents voted against the passage of the legislation.

2. The method of claim 1 further comprising distributing the Donor's monetary campaign contribution pledge to campaign funds according to the allocation, the monetary campaign contribution pledges becoming contributions upon distribution.

3. The method of claim 1 further comprising the computer system allocating the Donor's monetary campaign contribution pledge to the seats of the legislative body such that if for whatever reason a portion of the monetary campaign contribution pledge cannot be allocated, the portion becomes an unallocated portion of the monetary campaign contribution pledge.

4. The method of claim 3 further comprising the steps of:
a. the Donor providing instructions for distributing the unallocated portion or portions of the monetary campaign contribution pledge; and
b. distributing the unallocated portion or portions of the monetary campaign contribution pledge as instructed by the Donor.

5. The method of claim 1 further comprising the step of publishing the total number of Donors for and against the piece of legislation.

6. The method of claim 1 further comprising the step of the computer system allowing the donor to change their indication of whether the Donor is either for or against passage of the legislation.

7. The method of claim 1 further comprising the step of the computer system accumulating allocations over time for a given seat such that allocations from multiple Donors on multiple pieces of legislation are distributed together.

8. The method of claim 2 further comprising the step of reporting Donors' contributions according to government rules and regulations.

9. The method of claim 1 further comprising, the steps of:
a. when receiving the monetary campaign contribution pledge from the Donor, the Donor providing the Donor's demographic data; and
b. compiling a statistical report on multiple Donors' demographic data.

10. The method of claim 9 further comprising keeping one or more pieces of the Donor's demographic data confidential.

11. A method of allocating monetary campaign contributions using a computer system accessible through an interactive interface and programmed to process and allocate monetary campaign contribution pledges from one or more Donors, the method comprising:
a. a Donor accessing the interactive interface and entering a monetary campaign contribution pledge by:
i. identifying a piece of legislation pending before a legislative body, the legislative body consisting of a plurality of seats, each seat having an incumbent capable of voting either for or against the legislation, the incumbent occupying the seat for a term at the end of which the incumbent may run against at least one challenger for occupation of the seat, the incumbent and the challenger each maintaining at least one election campaign fund for the purpose of running for the seat;
ii. indicating whether the Donor is either for or against passage of the legislation;
iii. specifying a reward portion of the monetary campaign contribution pledge to be allocated to rewarding incumbents who voted for passage of the legislation if the Donor was for passage of the legislation or incumbents who voted against passage of the legislation if the Donor was against passage of the legislation;
iv. specifying a penalty portion of the monetary campaign contribution pledge to be allocated to penalizing incumbents who voted for passage of the legislation if the Donor was against passage of the legislation or incumbents who voted against passage of the legislation if the Donor was for passage of the legislation; and
v. identifying the amount of the monetary campaign contribution pledge;
b. the computer system processing the monetary campaign contribution pledge;
c. the computer system monitoring the legislative body's action on the legislation; and
d. the computer system allocating the reward and penalty portions of the Donor's monetary campaign contribution pledge to the seats of the legislative body such that:
i. the reward portion is allocated to seats whose incumbents voted for the passage of the legislation if the Donor indicated the Donor was for passage of the legislation and to seats whose incumbents voted against the passage of the legislation if the Donor indicated the Donor was against passage of the legislation; and
ii. the penalty portion is allocated to at least one challenger for occupation of seats whose incumbents voted against the passage of the legislation if the Donor indicated the Donor was for the legislation and to at least one challenger for occupation of seats whose incumbents voted for the legislation if the Donor indicated the Donor was against the legislation.

12. The method of claim 11 further comprising distributing the Donor's monetary campaign contribution pledge to campaign funds according to the allocation, the monetary campaign contribution pledges becoming contributions upon distribution.

13. The method of claim 11 further comprising the computer system allocating the Donor's monetary campaign contribution pledge to the seats of the legislative body such that if for whatever reason a portion of the monetary campaign contribution pledge cannot be allocated, the portion becomes an unallocated portion of the monetary campaign contribution pledge.

14. The method of claim 13 further comprising the steps of:
a. the Donor providing instructions for distributing the unallocated portion or portions of the monetary campaign contribution pledge; and
b. distributing the unallocated portion or portions of the monetary campaign contribution pledge as instructed by the Donor.

15. The method of claim 11 further comprising the step of publishing the total number of Donors for and against the piece of legislation.

16. The method of claim 11 further comprising the step of the computer system allowing the donor to change their specification of a reward or penalty portion of the monetary campaign contribution pledge.

17. The method of claim 11 further comprising the step of the computer system accumulating allocations over time for a given seat such that allocations from multiple Donors on multiple pieces of legislation are distributed together.

18. The method of claim 12 further comprising the step of reporting Donors' contributions according to government rules and regulations.

19. The method of claim 11 further comprising, the steps of:
a. when receiving the monetary campaign contribution pledge from the Donor, the Donor providing the Donor's demographic data; and
b. compiling a statistical report on multiple Donors' demographic data.

20. The method of claim 19 further comprising keeping one or more pieces of the Donor's demographic data confidential.

21. (canceled)

22. (canceled)

23. (canceled)

24. (canceled)

25. (canceled)
